(19) United States
(12) Patent Application Publication
(10) Pub. No.: US 2011/0191253 A1
(43) Pub. Date: Aug. 4, 2011

(54) USE OF MOBILE DEVICES FOR COMMUNICATING SOUND-BASED VIRTUAL TRANSACTION DATA

(75) Inventor: Orest Pilskalns, Missoula, MT (US)

(73) Assignee: GEOMONKEY, INC., Vancouver, WA (US)

(21) Appl. No.: 13/085,379

(22) Filed: Apr. 12, 2011

Related U.S. Application Data
(63) Continuation-in-part of application No. 12/762,122, filed on Apr. 16, 2010.
(60) Provisional application No. 61/170,554, filed on Apr. 17, 2009.

(51) Int. Cl. G06Q 20/00; G06Q 30/00

(52) U.S. Cl. 705/71; 705/14.27; 705/30

(57) ABSTRACT

The present application relates to the use of mobile devices for viewing and publishing location-based user information. One example allows a user of a mobile device to access content associated with a virtual version of an entity that exists at a physical location regardless of a location of the mobile device. This example enables the user to submit content to the virtual version when the mobile device is proximate the physical location.

### PRIORITY

This patent application is a continuation-in-part of U.S. patent application Ser. No. 12/762,122, filed on Apr. 16, 2010, which in turn claims priority from U.S. Provisional Application No. 61/170,554, filed on Apr. 17, 2009, both of which are incorporated by reference in their entirety.

### BACKGROUND

Numerous tools exist for electronically presenting geographic information to users. Very few tools exist for obtaining real-time geographic information from users. Many users have mobile devices from which they receive and transmit information to and from multiple digital locations. There are not many useful implementations linking this mobile user-transmitted data with actual geographical locations in a manner that would be useful to the user.

### SUMMARY

The present application relates to the use of mobile devices for viewing and publishing location-based user information.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIG. 1 shows a scenario in which viewing and publishing of location-based user information relative to a mobile device can be employed in accordance with some implementations of the present concepts.

FIG. 2 shows a system that can accomplish viewing and publishing of location-based user information relative to a mobile device in accordance with some implementations of the present concepts.

FIGS. 3-7 are flowcharts for accomplishing viewing and publishing of location-based user information relative to a mobile device in accordance with some implementations of the present concepts.

FIGS. 8 and 9 show a system that can accomplish sound-based virtual transactions in accordance with some implementations of the present concepts.

FIGS. 10A and 10B show graphical user interfaces for virtual transactions in accordance with some implementations of the present concepts.

FIGS. 11-14 are flowcharts for accomplishing sound-based virtual transactions in accordance with some implementations of the present concepts.

### DETAILED DESCRIPTION

### Overview

The present application relates to the use of mobile devices for viewing and publishing location-based user information. In one example, a user may physically enter a place of interest. The place of interest may be associated with an entity, such as a business or organization. In one example, the place of interest (hereinafter, “physical location” or “geographical location”) can be a restaurant or sporting arena, among others. For purposes of explanation, the following discussion utilizes examples where the physical location is a business, but such need not be the case.

When the user enters the physical location, the user may at the same time, choose to (or by default) enter a virtual version of the business (hereinafter, “virtual business”) on the user's mobile device. The user may then enter content, such as a text-based comment or capture a digital picture, audio, video, review, or message on the mobile device and, in response, automatically transmit that content to a digital “wall” on the virtual business.

In some implementations, the user may only be allowed to access the physical location's virtual business when the user (and his/her mobile device) is proximate to, or within the physical location. Thus, the user may be on the business's property or in close proximity. For instance, in a food court scenario, the user may be allowed to post content to a virtual version of one of the restaurants of the food court even though the user may be seated in a common seating area.

In one example, the virtual version of the physical location may not even exist, until the user captures or generates data or information for that physical location, wherein after that, information is transmitted, and a “virtual wall” for the business is created. In some configurations, after creation of a new business virtual wall, all future users can see postings for that virtual wall and post to that virtual wall subject to some constraint. For instance, examples of constraints can be whether the user is within a certain range of the physical location of the business and/or whether the user has registered for the service.

In other scenarios, a place of interest, such as a business may have an existing virtual business, such as a web-site or virtual “wall”. Some implementations can adjust privileges to the user relative to the virtual business based upon the constraints. For instance, the user may be able to access the business's web-site from any physical location. However, access to on-site coupons or specials can be constrained based upon the user's physical location, i.e., the user can only see the on-site coupons or specials when the user (and the mobile device) are proximate the business's physical location.

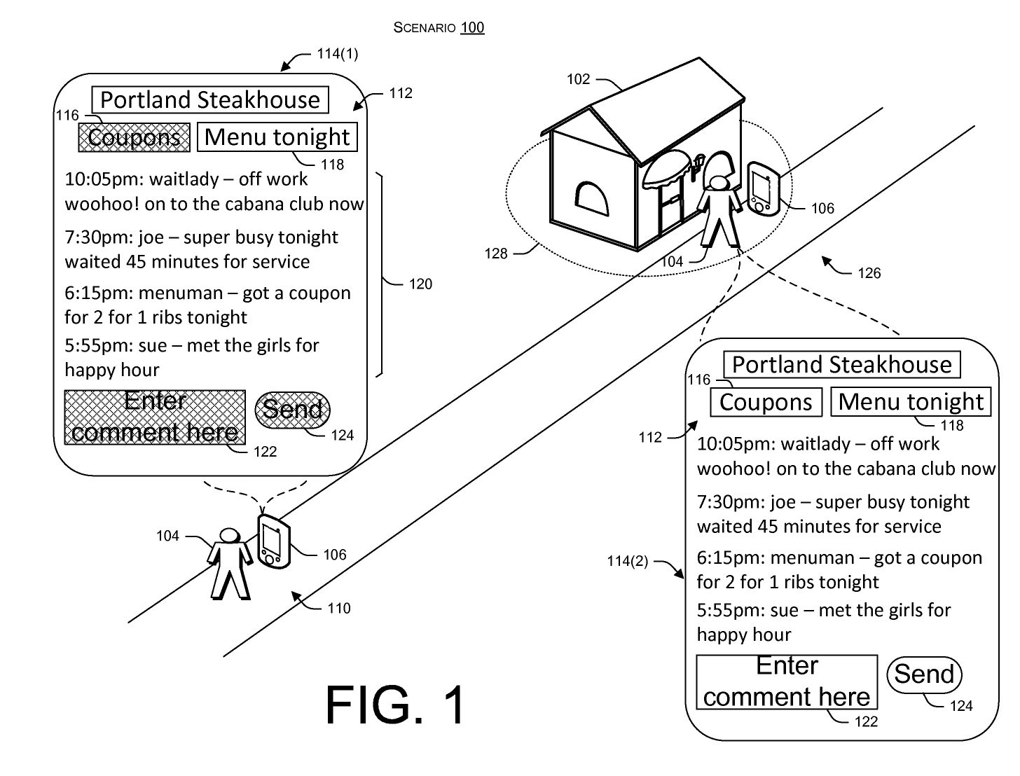

For introductory purposes consider FIG. 1 that describes viewing and publishing location-based user information in scenario 100. Scenario 100 involves a hypothetical business named ‘Portland Steakhouse’ that has a physical location indicated at 102. This scenario also involves a user 104 that has a mobile device 106.

At point 110, the user 104 is on his/her way to the physical location 102 but is not proximate the physical location. In this example, at point 110 the user can access virtual content associated with the Portland Steakhouse. For example, a virtual wall 112 of the Portland Steakhouse is displayed on mobile device 106 and shown on an enlarged display at 114(1). At this point, the user can see content on the virtual wall. The virtual wall 112 includes a ‘coupons’ dialog box 116, a ‘menu tonight’ dialog box 118, a comments section 120, an ‘enter comment’ dialog box 122, and a ‘send’ dialog box 124. However, some of the options presented on the virtual wall are unavailable to the user 104 at this point based upon one or more constraints. For instance, the user can see the ‘comments’ section 120 and access the ‘menu tonight’ dialog box 118. However, as indicated by cross-hatching, the user cannot access the ‘coupons’ dialog box 116, or enter a comment in the ‘enter comment’ dialog box 122. This inaccessibility can be based upon a constraint associated with the user's location relative to the business's physical location 102 (i.e., since the user is not proximate the physical location 102 the user's privileges relative to the content are constrained).

Subsequently, at point 126, the user reaches the physical location 102. In this implementation, at point 126 the user 104 can access the virtual business associated with the Portland Steakhouse with enhanced privileges relative to the virtual business. Stated another way, at point 126 the user 104 enters, or is proximate to, the physical location 102 as indicated by dotted line 128. At point 126, the user may be automatically given privileges (or constraints lifted) associated with the virtual business based upon the user's location being proximate to the physical location. In this example, the user can access additional content and/or features in the virtual business based upon the proximity. Specifically, in enlarged display 114(2) the ‘coupons’ dialog box 116, ‘enter comment’ dialog box 122, and ‘send’ dialog box 124 are now available to the user.

The above discussed implementations can provide several potential advantages. For instance, these configurations can produce more reliable content on the virtual business. For example, limiting comment posting to users that are actually at the business can reduce the chances that pranksters or competing businesses might post inaccurate comments.

Some implementations can offer still other virtual features relative to the user's location. For instance, assume that a coffee shop has an offer where upon purchasing nine coffees, the tenth is free. This offer can be manifest as a virtual punch card that is much more convenient than a traditional paper punch card. Each time the user visits the coffee shop, the coffee shop's virtual wall can be automatically presented on the user's mobile device based upon location information. The virtual wall can include the virtual punch card. The user could click on the virtual punch card or the virtual punch card could be automatically presented to the user on the virtual wall. For instance, the virtual punch card can be presented on the virtual wall as a dialog box that says “Dear user—since you are at the coffee shop please have your virtual account punched (i.e. credited).”

The process could be rather simple, such as an employee who rings-up the user enters a unique identification for the user and a number of coffees purchased. The information can be uploaded to a service that manages the virtual wall to credit the user's account. A more automated configuration may automatically determine the user's identity such as through the user's credit card and correlate the identity with the number of coffees charged to the user (such as based upon SKUs). This information could then be utilized to credit the user's virtual punch card.

The above described virtual punch cards avoid the user having to carry around a bunch of cards and to sort through them, etc. Further, these implementations can ‘follow the user’ in situations where the business has multiple locations, further avoiding the typical scenario where the user leaves their paper punch card at their favorite location and then doesn't have it when they go to a different location.

In summary, there is great value to users of a business or other gathering place (school, sports arena, park or outdoor locale) to view and post information specific to that locale, in real-time, from a mobile device. In some implementations this feature may be provided automatically to the user. For instance, in the Portland Steakhouse example, when the user reaches the physical location 102, the virtual business's web-site or virtual wall may be automatically launched on the user's mobile device based upon location information obtained from the mobile device. In another example, when a user enters a stadium for a sporting event, a virtual wall of the league hosting the event, home team, and/or visiting team may automatically be displayed on the user's mobile device without any effort by the user. Access to and/or privileges associated with the virtual wall may be constrained based upon the user's physical location.

### System Example

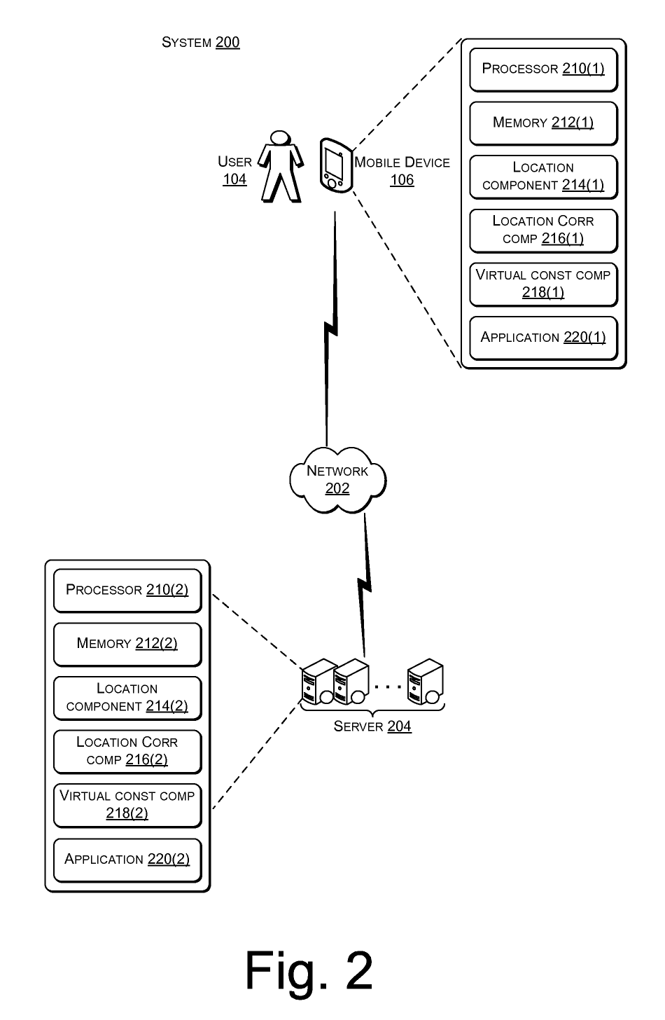

FIG. 2 depicts an illustrative architecture or system 200 configured to support viewing and publishing of location-based user information. System 200 includes mobile device 106 that can be associated with user 104. System 200 also includes network 202 and a server 204. Mobile device 106 can be any sort of device that has some processing capability and a capability to communicate over a network such as network 202. For instance, mobile device 106 may be a mobile phone, a personal digital assistant (PDA), a laptop computer, a portable media player (PMP) (e.g., a portable video player (PVP), a digital audio player (DAP), etc.), or any other type of existing, evolving, or yet to be developed computing device.

Meanwhile, network 202, which is configured to couple mobile device 106 and server 204, may comprise the Internet, a Local Area Network (LAN), a Wide Area Network (WAN), a wireless network, and/or the like. Here, network 202 may comprise a wireless cellular network or a wireless fidelity (Wi-Fi) network. Also, while only a single network is illustrated, the system may entail multiple networks.

As illustrated, either or both of mobile device 106 and server 204 can include one or more processors 210, memory 212, location component 214, location correlation component 216, virtual constraint component 218 and/or application(s) 220. Processor 210 can execute computer readable instructions, such as may be stored on memory 212, to cause a method to be performed.

Location component 214 can be configured to periodically and/or from time-to-time identify the location of mobile device 106. For instance, location component 214 can employ GPS technologies and/or Wi-Fi triangulation technologies, among others, to identify the location of mobile device 106. In some cases, the location of the mobile device can be identified on the mobile device by location component 214(1). In other configurations, the mobile device's location can be identified remotely by location component 214(2).

The mobile device's identified location can be communicated to location correlation component 216. The location correlation component can compare the mobile device's location to a location of a place of interest. The location of the place of interest can be determined in the same way as the location of the mobile device and/or be referenced in a look-up table. Stated another way, location correlation component 216 can determine whether the mobile device is proximate to a physical location. For instance, the user 104 may be using application 220 to surf a web-site associated with the physical location.

The location correlation component 216 can determine whether the mobile device 106 is proximate the physical location and communicate that information to the virtual constraints component 218. The virtual constraints component can authorize access to the web-site and/or subject the access to constraints, such as the proximity of location, received from the location correlation component 216. An example of such constrained access is described above relative to FIG. 1.

In some instances, the virtual constraints component 218 may be thought of as a component that manages virtual business and users. For instance, the virtual constraints component may include a mapping of businesses or other places of interest, their physical location, and their virtual content. The virtual constraints component may also maintain a mapping of users that are interested in receiving location specific virtual content. The virtual constraints component can then match users to virtual content based upon the users' physical location information obtained from location component 214.

Stated another way, system 200 enables strategies for annotating a digital space inside a virtual business or gathering place, among others. In some configurations, the system can aggregate geo-located information in real time from users' mobile devices, such as mobile device 106. The aggregated geo-located information can be stored on computer-readable media, such as memory 212, with computer-executable instructions related to that computer-readable media. The computer-readable media can occur on mobile devices and/or on remote computing devices, such as server 204. In some implementations, the geo-located information can be automatically retrieved when an individual mobile device user enters a geographic area that corresponds to the geo-located information.

According to one exemplary aspect, the strategy can involve uploading to a computing device, such as server 204, an object(s) in response to a first instruction. For example, user 104 can issue the first instruction from mobile device 106 when he/she desires to upload an object or other content. In another instance, the first instruction may be issued automatically when the user enters an area associated with the physical business. Server 204 can store the object based upon the location of the mobile device 106 that captured the object. The object may correspond to a text message, digital photograph, media file, photo, video, audio, and so on.

In some implementations, the user location is determined using a location service provided by location component 214(1) on the mobile device 106, such as global positioning system (GPS) or Wi-Fi triangulation. In some cases, the user location may be determined based on user input of address or latitude/longitude coordinates. The strategy further involves, in response to a second instruction, linking the uploaded object to a selected location (or default location) within the virtual business, to thereby provide an annotated “wall”. The second instruction can be issued automatically or can be user generated. For instance, if the user's location is proximate to several businesses (i.e., physical locations), the user may specify which corresponding virtual business the object should be associated with. In this strategy, the linking can take place by associating the object with the geographical location and sending the combined information to the server 204.

If the virtual business associated with a physical location does not already exist in the server 204, it can be automatically created on the server. Any other user that enters the virtual business can see postings to the digital “wall” (potentially subject to the constraints) by automatically communicating with the server. In some implementations, a query from mobile devices can use location and returned postings that can be constrained to only that location.

In another example, user 104 may enter a physical location of a business and at the same time, enter a virtual version of the business on the user's mobile device 106. The virtual entrance may trigger an action on behalf of the business wherein the user may then receive information related to the business on the user's mobile device. In this case, the information transmitted to the user's mobile device may be coupons or messaging related to specials or relating to other users who have recently entered the business. In another aspect, the user may initiate the receipt of coupons, messaging or other information from the business to the user's mobile device.

According to another exemplary inventive aspect, the strategy can involve giving the user the option of viewing their digital postings at a later date, either from mobile device 106 or from a computer online interface. The user could in fact view their own historical postings via a private or password-protected web interface that displays their postings on an annotated map, based on the geographical location at which they were captured.

In another example, the owner of the business may receive access to the digital information posted by mobile users on the virtual business, and may be granted access to edit and modify the presence of the virtual business within the system. One example of this may include modifying the look and feel of the virtual business' interface to resemble the physical representation of the business. The owner may also choose to define, such as using an online interface, a geographical boundary around the business. In some implementations, the geographical boundary can be stored as the business location utilized by the location correlation component 216(2). Subsequently, digital postings (or a filtered sub-set thereof) within that geographical boundary (i.e., in a defined area) can be posted to the virtual wall of that business. Virtual boundaries may be created automatically when a user first posts a message. A k-means clustering algorithm is one approach that may be applied in order to auto-define boundaries, if a previous bounds is not defined.

In another scenario, assume for purposes of explanation that two or more users are posting information to a virtual “wall” at approximately the same time. The users' mobile devices can indicate that the users or “posters” are currently in the same area. In some cases, the system can allow the users to communicate via a “chat” interface. In some instances, the chat interface may be limited to the posters (i.e., private). In this example, the digital interactions may provide opportunity for person-to-person digital interaction, as well as in-person interactions.

In another example, users viewing the content on a virtual wall may be able to rate that content using a nominal scale. The ratings may be used to help determine the ordering of the virtual wall postings. Other considerations for ordering the wall postings could include time of posting, length of posting, and ratings on previously rated postings. Postings can be anonymous or associated with a user account.

In another example, the posted information may be viewed from a web interface in the form of a “hot spots” map, wherein clusters of postings may appear as “hot spots” on the geographical location.

Another scenario involving location-based user information can involve linking the virtual business to physical transactions. For example, once a person enters a virtual business, he/she can also access links to pay for parking, for example, or reserve a table, a tee time, or purchase items or merchandise. A further scenario can involve linking the virtual business to other information so a user could access local travel info, history, etc. Still another scenario can involve linking the virtual business to other businesses nearby (i.e. users at a concert venue could find the nearest restaurant or coffee shop). Another scenario can involve sub-domains within a virtual business, such as various holes on a golf course, independent buildings within a complex (i.e. library on a college campus), sections of an airport, etc.

### Method Examples

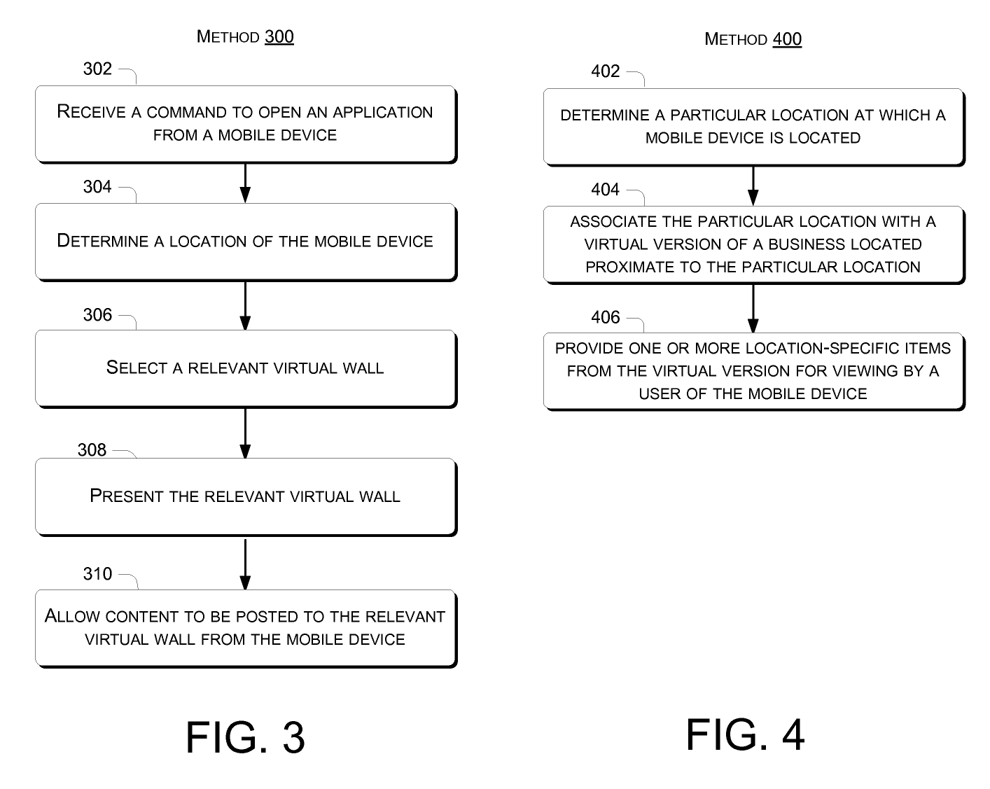

FIG. 3 illustrates a flowchart of a process, technique, or method 300 that is consistent with at least some implementations of the present location-based user information concepts.

At block 302, the method receives a command to open an application from a mobile device. In some cases, the application may be a web browser application or a social networking application. The application may be resident on the mobile device or may be resident on a server device that is communicatively linked with the mobile device.

At block 304, the method determines a location of the mobile device. Various techniques can be employed to determine the location. Non-limiting examples are described above relative to FIG. 2.

At block 306, the method selects a relevant virtual wall. The relevant virtual wall can be selected by correlating a location of the mobile device with a virtual wall of a place of interest that is proximate to the location of the mobile device.

At block 308, the method presents the relevant virtual wall. For instance, the relevant virtual wall can be presented on the mobile device. When the mobile device is proximate a physical business corresponding to the virtual wall, the virtual wall may be presented with less constraints than when the mobile device is not proximate the location of the physical business.

At block 310, the method allows content to be posted to the relevant virtual wall from the mobile device. The privilege of posting content to the virtual wall may be removed when the user leaves the location of the physical business.

FIG. 4 illustrates a flowchart of a process, technique, or method 400 that is consistent with at least some implementations of the present location-based user information concepts.

At block 402, the method determines a particular location at which a mobile device is located.

At block 404, the method associates the particular location with a virtual version of a business located proximate to the particular location.

At block 406, the method provides one or more location-specific items from the virtual version for viewing by a user of the mobile device. For instance, ‘on-site’ coupons or specials may be presented for viewing.

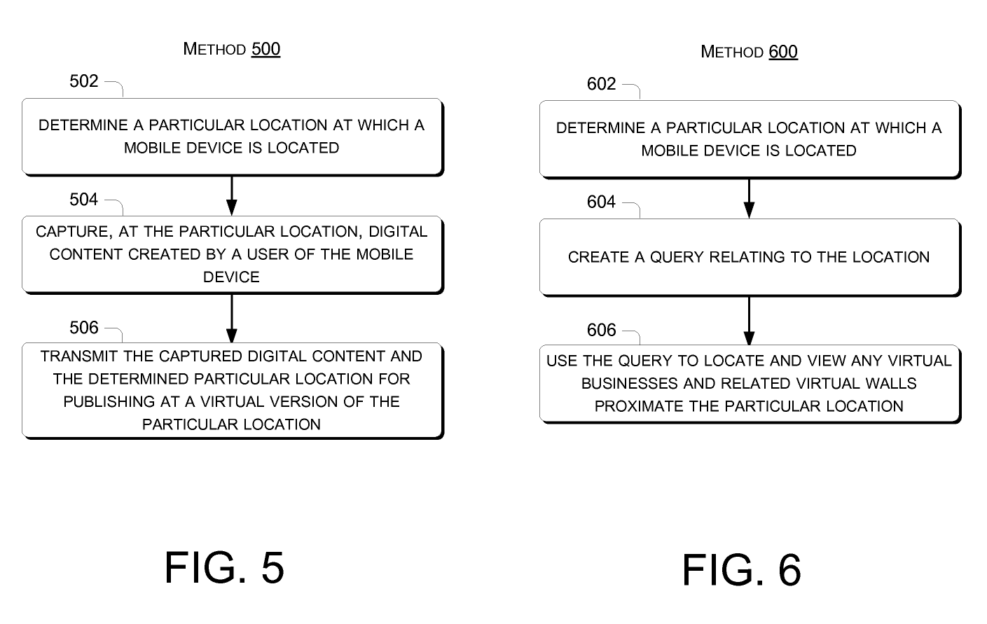

FIG. 5 illustrates a flowchart of a process, technique, or method 500 that is consistent with at least some implementations of the present location-based user information concepts.

At block 502, the method determines a particular location at which a mobile device is located.

At block 504, the method captures, at the particular location, digital content created by a user of the mobile device. In some implementations, the capture may only be allowed when the particular location corresponds to a physical location of the place of interest.

At block 506, the method transmits the captured digital content and the determined particular location for publishing at a virtual version of the particular location.

FIG. 6 illustrates a flowchart of a process, technique, or method 600 that is consistent with at least some implementations of the present location-based user information concepts.

At block 602, the method determines a particular location at which a mobile device is located.

At block 604, the method creates a query relating to the location.

At block 606, the method uses the query to locate and view any virtual businesses and related virtual walls proximate the particular location.

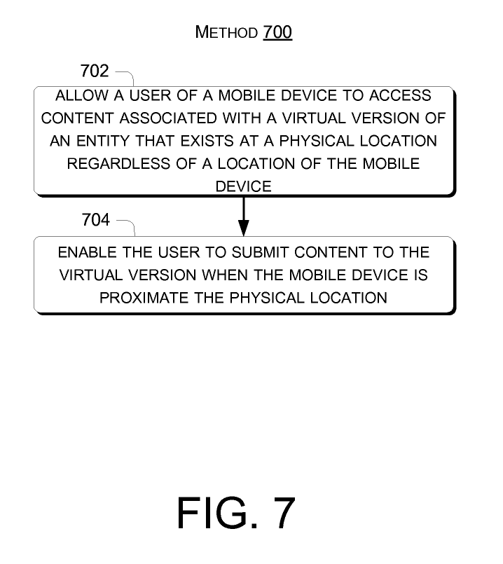

FIG. 7 illustrates a flowchart of a process, technique, or method 700 that is consistent with at least some implementations of the present location-based user information concepts.

At block 702, the method allows a user of a mobile device to access content associated with a virtual version of an entity that exists at a physical location regardless of a location of the mobile device.

At block 704, the method enables the user to submit content to the virtual version when the mobile device is proximate the physical location.

### Sound-Based Transaction System Example

As discussed above, system 200 can be used to implement various types of transactions using mobile device 106. Further, as mentioned above, mobile device 106 can communicate using wireless or cellular technologies with server 204 over network 202. In some implementations, mobile device 106 can also be configured to communicate with one or more devices at a particular business location. For example, mobile device 106 can be configured to receive information from a terminal or other device associated with Portland Steakhouse while the user is proximate to physical location 102.

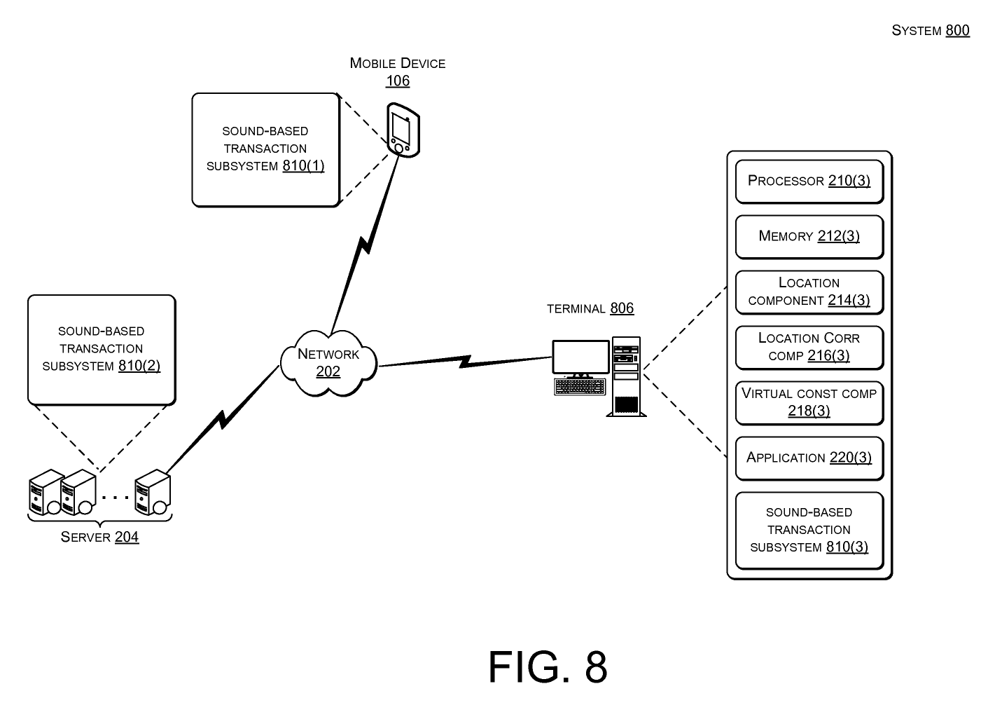

FIG. 8 depicts an illustrative architecture of system 800 that is configured to support sound-based transactions. System 800 can be similar to system 200 as set forth above with respect to FIG. 2, and can include mobile device 106, network 202, and server 204. Unless otherwise indicated, mobile device 106, network 202, and server 204 can generally include such components as discussed above for system 200.

Furthermore, system 800 can include a terminal 806. Generally speaking, terminal 806 can be any kind of device that has some kind of processing capability, e.g., can be similar to mobile device 106, server 104, etc. Terminal 806 can be used at location 102 by a business, e.g., Portland Steakhouse, for transaction processing. Terminal 806 can include similar components as mentioned above with respect to mobile device 106 and server 204, e.g., processor 210(3), memory 212(3), location component 214(3), location correlation component 216(3), virtual constraint component 218(3), and/or application 220(3). Additionally, as shown in FIG. 8, mobile device 106, server 204, and/or terminal 806 can include sound-based transaction subsystems 810(1), 810(2), and 810(3), respectively.

Sound-based transaction subsystem 810(3) of terminal 806 can be configured to send virtual transaction data to mobile device 106 using sound waves. For example, sound-based transaction subsystem 810(3) can be configured to play one or more sounds to implement virtual transactions such as punches for the virtual punch-card implementation discussed above. Sound-based transaction subsystem 810(1) of mobile device 106 can be configured to receive the sound waves from terminal 806 while proximate to physical location 102, e.g., next to terminal 806 while user 104 is inside Portland Steakhouse.

Sound-based transaction subsystem 810(1) of mobile device 106 can also be configured to submit the virtual transaction data, e.g., the virtual card punch, to sound-based transaction subsystem 810(2) of server 204 over network 202. Sound-based transaction subsystem 810(2) of server 204 can be configured to record the virtual transaction and perform accounting or other functions associated with the virtual transaction. For example, sound-based transaction subsystem 810(2) can be configured to account for how many punches user 104 has on their virtual punch card. Furthermore, if user 104 reaches a certain number of punches that entitles them to a free item from Portland Steakhouse, sound-based transaction subsystem 810(2) can send data over network 202 to terminal 806 indicating that the user should receive the free item.

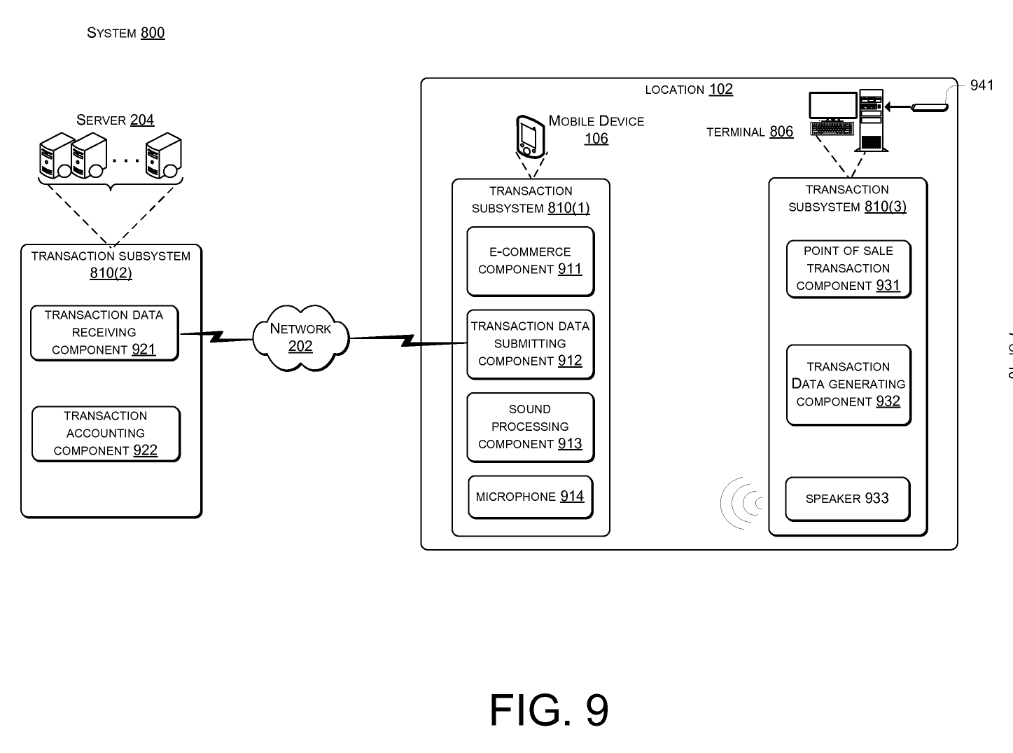

FIG. 9 depicts subsystems 810(1), (2), and (3) in more detail. As shown in FIG. 9, transaction subsystem 810(1) of mobile device 106 can include an e-commerce component 911, a transaction data submitting component 912, a sound processing component 913, and a microphone 914. Transaction subsystem 810(2) of server 204 can include a transaction data receiving component 921 and a transaction accounting component 922. Transaction subsystem 810(3) of terminal 806 can include a point of sale transaction component 931, a transaction data generating component 932, and a speaker 933. In some implementations, components of terminal 806 can be embodied instead on a peripheral device 941, such as a universal serial bus (“USB”) dongle or drive. In one particular implementation, transaction data generating component 932 and speaker 933 are embodied on peripheral device 941.

The following particular example describes interaction between mobile device 106, server 204, and terminal 806 to implement sound-based transactions using system 800. However, note that the following is but one example, and the various processing steps or techniques disclosed herein can be performed by any of mobile device 106, server 204, and terminal 806.

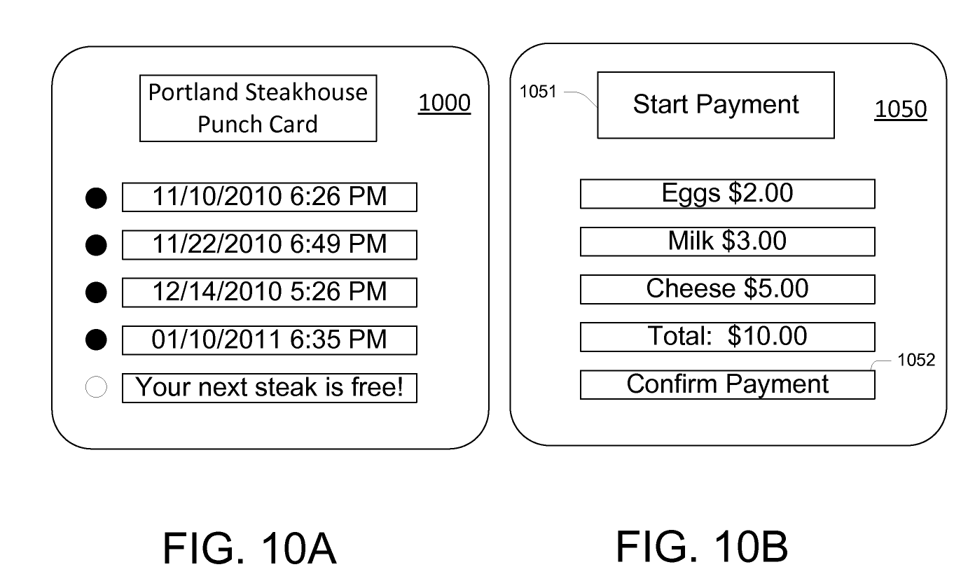

E-commerce component 911 can be configured to cause a transaction prompt to appear on mobile device 106. For example, as shown in FIG. 10A, e-commerce component 911 can be configured to cause prompt 1000 for a virtual punch card to be displayed responsive to the user arriving at location 102. In some implementations, other transaction information can be displayed on mobile device 106, e.g., a coupon, a bill, a menu, etc.

The user can make a purchase from the business, which can be entered by the business using point of sale transaction component 931 at terminal 806. The user can then receive a virtual punch by placing mobile device 106 next to speaker 933. Transaction data generating component 932 can be configured to cause speaker 933 to play a predetermined sound corresponding to virtual transaction data. For example, speaker 933 can play a predetermined frequency, code, or other sound that uniquely identifies Portland Steakhouse and/or an individual virtual card punch.

In some implementations, transaction data generating component 932 is preconfigured or hardwired to play a single business identifier via speaker 933, e.g., an identifier for Portland Steakhouse. In such implementations, transaction data generating component 932 can include a button that, when pressed, plays the virtual identifier via speaker 933. In further implementations, discussed in more detail below, transaction data generating component 932 causes speaker 933 to play different sounds at different times representing, e.g., different virtual transactions.

Microphone 914 of transaction subsystem 810(1) can receive the sound from speaker 933. Sound processing component 913 can perform analog-to-digital processing of the sound to convert the sound to a digital representation. In some implementations, sound processing component 913 also performs signal processing to identify individual components of the sound. For example, sound processing component 913 can perform digital fast-Fourier transforms, wavelet transforms, etc. to transform the digital sound representation from time domain to frequency domain. In some implementations, sound processing component 913 converts the received sound into the virtual transaction data that was generated by transaction data generating component 932, e.g., a virtual identifier for Portland Steakhouse and/or an individual punch, etc.

Virtual transaction data can be encoded in the analog sound in many different fashions. In one particular example, speaker 933 can play “notes” at different frequencies from 100 hertz to 20,000 hertz. The notes can skip intervals, e.g., every 100 hertz, so that mobile device 106 and/or server 204 can more easily resolve the note using transforms. In some implementations, the analog sound includes several notes played concurrently, e.g., a “chord.” The range of frequencies used, the number of notes played concurrently, and the frequency intervals that are skipped (among other things) can determine how many unique identifiers can be played as individual unique virtual transaction data items. As one example, using five-note chords, frequencies from 100 hertz to 20,000 hertz, and skipping every 100 hertz, approximately 2.5 billion unique identifiers are possible. Using 20-note chords, a unique 128-bit key could be transmitted and used as a virtual transaction identifier.

In one example, identifiers can be divided up across the range of possible unique identifiers in various manners. For example, from the 2.5 billion identifiers mentioned in the 5-note scheme above, each business could be assigned a predetermined range of identifiers. This is also true for the 128-bit implementation mentioned, e.g., the identifiers can include a group of bits (e.g., most-significant 32 bits) that uniquely identify each business and a different group of bits (lower-order 96 bits) that uniquely identify individual transaction data items. In other implementations, a subset of notes in the chord (e.g., the two lowest-frequency notes) can be used to identify the business, and the remaining notes (e.g., the three higher-frequency notes) can identify the individual virtual transaction data item.

The relative cost of microphone 914, speaker 933, and/or sound processing component 913 can vary depending on what encoding or protocols these components need to support. For example, using chords with more notes and/or a wider range of frequencies may generally require more expensive components that are capable of processing the range of notes concurrently. However, using more notes may also tend to increase the security of system 800, as fewer devices are likely to be able to decode the analog sound waves to identify the virtual transaction data encoded therein. Nevertheless, as discussed in more detail below, various logical techniques can also be used to address security concerns, e.g., by validating virtual transaction data and ignoring invalid transactions.

Transaction data submitting component 912 of transaction subsystem 810(1) can be configured to submit virtual transaction data to server 204. In implementations where sound processing component 913 converts (e.g., decodes) the sound to virtual transaction data, transaction data submitting component 912 can submit the virtual transaction data instead of the digital sound representation. However, for security purposes, in some implementations, mobile device 106 is unable to convert from sound data to virtual transaction data. In such implementations, transaction submitting component 913 can be configured to send the digital sound representation itself without processing the digital sound representation to derive the encoded virtual transaction data included therein. In such implementations, server 204 can include a sound processing component (not shown) configured to derive the virtual transaction data from the digital sound representation.

Transaction data receiving component 921 can be configured to receive the virtual transaction data via network 202. Transaction accounting component 922 can, in turn, be configured to process the virtual transaction data and perform accounting based on the virtual transaction data. For example, as shown in FIG. 10A, the user has four punches on their virtual punch card. Transaction accounting component 922 can track virtual transactions (e.g., punches) and determine whether the user has satisfied a predetermined threshold to receive a free item. In this case, the user may have received their fifth steak at Portland Steakhouse and receive the steak for free. Virtual transaction data examples other than business identifiers and virtual punch identifiers are discussed in more detail below.

In the circumstances discussed above, virtual constraint component 218(2) of server 104 can be configured to determine whether the mobile device 106 is proximate to location 104 before allowing the virtual punch to take place. In some implementations, virtual constraint component 218(2) can cause microphone 914 to be turned off by default and enabled when the user is proximate to a known business location. For example, virtual constraint component 218(2) of server 204 can send instructions to mobile device 106 to turn microphone on or off depending on whether mobile device 106 is currently in a location that supports virtual punch cards or other virtual transactions.

As another example, virtual constraint component 218(2) can instruct sound processing component 913 or some part thereof to be inoperable unless the user is proximate to a business location that supports virtual transactions. Again, this technique can be implemented by virtual constraint component 218(2) sending an instruction to mobile device 106. Similar techniques can be applied by instructing transaction data submitting component 912 to refrain from submitting transactions when the location of mobile device 106 does not correlate to a business location that supports virtual transactions.

In further embodiments, sound processing component 913 can be restricted using filtering or other techniques to only listen for particular frequencies and/or codes that are particular to the location of mobile device 106. As an example, Portland Steakhouse may have assigned frequencies between 30-40 kilohertz, and Dave's Burgers may have assigned frequencies between 40-50 kilohertz. Virtual constraint component 218(2) may instruct sound processing component 913 to listen for frequencies between 30-40 kilohertz when mobile device 106 is proximate to Portland Steakhouse, and for frequencies between 40-50 kilohertz when mobile device 106 is proximate to Dave's Burgers. In implementations where chords are used to submit virtual transaction data, individual businesses can share some frequencies with other businesses and have one or more unique identifying frequencies. In other implementations, a particular business may not have any individual unique frequency, but instead can have a unique combination of frequencies, e.g., a unique chord. In such implementations, each frequency in the unique chord may be shared with another business, but no other business uses a chord with the same combination of frequencies.

As another example, virtual constraint component 218(2) can cause transaction accounting component 922 to only process certain virtual transactions, e.g., award a virtual punch, when the user is proximate to a business location associated with the virtual transaction and/or a particular application or component is running on mobile device 106, e.g., e-commerce component 911. As discussed above, this technique can also be accomplished by virtual constraint component 218(2) correlating the user's location to the business location associated with the punch card. In some implementations, transaction data submitting component 912 is configured to submit virtual transaction data with a timestamp to server 204. In such implementations, virtual constraint component 218(2) can correlate the virtual transaction data and location offline, e.g., by logging timestamped virtual transaction data and location data for subsequent processing. Thus, transaction accounting component 922 can award the virtual punch after mobile device 106 has left the proximity of the business location, provided mobile device 106 was in the proximity at the time indicated on the timestamp. Timestamps can also be used to indicate when e-commerce component 911 is running on mobile device 106 and transactions disallowed for time periods when the timestamps indicate that e-commerce component 911 was not executing.

Timestamps can also be used to handle circumstances where mobile device 106 cannot (e.g., poor cell reception) or should not (e.g., in an airplane) transmit wirelessly. Mobile device 106 can locally store timestamped virtual transaction data for virtual transactions and upload the timestamped virtual transaction data to server 104 when it is possible or appropriate to do so. In some implementations, mobile device 106 also stores timestamped location data when it cannot or should not transmit wirelessly. The timestamped location data and timestamped virtual transaction data can be correlated later by server 104 using virtual constraint component 218(1). Note that the timestamps can either be applied by a trusted component on mobile device 106 and/or included in the sound transmitted by speaker 933.

Virtual constraint component 218(2) of server 204 can also be configured to identify potentially fraudulent transactions. For example, virtual constraint component 218(2) can be configured to identify duplicate virtual transaction data items, such as virtual punch identifiers. If transaction accounting component 922 receives two virtual punches having the same identification, this can be an indicator of an attempt to defraud the business. In implementations where virtual transactions do not have identifications (e.g., only a business ID is emitted by speaker 933), virtual constraint component 218(2) can use other techniques to identify potentially fraudulent transactions. For example, virtual constraint component 218(2) can enforce a restriction that only one mobile device can submit virtual punches to an individual punch card.

The various techniques discussed above with respect to virtual constraint component 218(2) can also be enforced locally at mobile device 106 using virtual constraint component 218(1) or at terminal 806 using virtual constraint component 218(3). More generally, processing described herein with respect to particular devices can be performed by other devices in system 800. As another example, mobile device 106 and/or terminal 806 can include a transaction accounting component such as component 922 that implements the accounting processing described above. In some implementations, terminal 806 essentially replaces server 204 and performs all of the processing disclosed herein with respect to server 204.

Using sound to communicate virtual transaction data in this manner may have certain advantages relative to other technologies, e.g., Bluetooth, RFID, 3G, etc. Radio technologies such as these often have relatively large ranges, and even a range of one meter may be sufficient to compromise security of virtual transaction data. Security can be compromised because it is possible using radio technologies to communicate virtual transaction data across ranges that may not involve mobile device 106 being in the proximity of the business location, or more specifically, terminal 806. Thus, if the location data provided by location component 214 is compromised, it may be possible to submit fraudulent virtual transaction data using mobile device 106 without being in the proximity of the business. In contrast, by using sound to communicate virtual transaction data, shorter effective ranges can be achieved simply by controlling the volume of the sound. To this end, in some implementations, terminal 806 is configured to automatically adjust the volume of sound produced by speaker 933 depending on the level of background noise. Likewise, mobile device 106 can be configured to automatically adjust the sensitivity of microphone 914 depending on the level of background noise.

Many off-the-shelf devices are already equipped with microphones and/or speakers that can perform the techniques discussed above. In some implementations, sound frequencies that are normally inaudible to humans can be used for the virtual transaction data, e.g., less than approximately 20 hertz or greater than approximately 20 kilohertz. Many existing off-the-shelf mobile devices have microphones with sufficient sensitivity to pick up such inaudible signals.

However, many existing terminal devices do not have a speaker with sufficient range to transmit such signals. Speaker 933 can be a specially-designed speaker that is capable of transmitting at inaudible frequencies, e.g., an add-on universal serial bus (USB) speaker such as peripheral device 941 that plugs into terminal 806. Such a speaker generally has relatively low cost. Moreover, in such implementations, mobile device 106 does not need to be retrofitted to accomplish the disclosed techniques. Furthermore, note that the disclosed techniques can also be implemented using human-audible frequencies, e.g., between 20 hertz and 20 kilohertz.

Implementing transaction data generating component 932 and speaker 933 together on peripheral device 941 can have certain advantages. For example, transaction data generating component 932 can be implemented as a trusted module that is shipped together with speaker 933. In such implementations, transaction data generating component 932 can be implemented as immutable or reconfigurable logic that controls speaker 933. Furthermore, transaction data generating component 932 can be embodied in a tamper-proof package that, if corrupted, disables transaction data generating component 932 and/or speaker 933. Furthermore, location component 214(3), location correlation component 216(3), and/or virtual constraint component 218(3) can be included on peripheral device 941 in a similar manner as mentioned above for transaction data generating component 932.

In some implementations, peripheral device 941 can also be configured to generate encrypted timestamps and/or virtual transaction data that are sent in encrypted form by terminal 806 to server 204. Server 204 can then decrypt the timestamps and/or virtual transaction data and compare them to timestamps and/or virtual transaction data provided by mobile device 106. For example, server 204 can enforce a requirement that timestamps for an individual virtual transaction received by mobile device 106 and terminal 806 are within a threshold time period of one another, e.g., 30 seconds, or otherwise prevent transaction accounting component 922 from processing the corresponding transaction.

The above-described implementations can be beneficial for an entity in operation control of server 204 and that controls manufacture of peripheral device 941, but may not have operational control of terminal 806 and/or mobile device 106. Because peripheral device 941 can include trusted and/or tamperproof modules that are responsible for driving speaker 933, the entity can have more confidence that transaction data submitted to server 204 is legitimate and not fraudulent. As one example, server 204 can send reconfiguration instructions to peripheral device 941 that cause peripheral device 941 to play different frequencies and/or codes. In such implementations, reconfiguration instructions may be communicated from server 204 to peripheral device 941 via network 202 and terminal 806.

In some implementations, transaction data generating component 932 is configured to cause speaker 933 to emit an audible indication of a transaction, e.g., an audible punch, in an audible frequency range. Terminal 806 can do so responsive to an instruction to register a virtual punch. Speaker 933 can also emit separate, nonaudible virtual transaction data for each virtual punch or other transaction. In other implementations, separate speakers can be used for audible and nonaudible signals.

Furthermore, speaker 933 can be configured with a permanent business identifier that is transmitted each time speaker 933 is activated for a virtual transaction. In such implementations, each business can have a different identifier and corresponding different sound signal. Speaker 933 can include a button that, when pressed, emits a sound that includes the business identifier and/or other virtual transaction data, such as a virtual transaction identifier. As mentioned above, the identifiers and sound signals can be reconfigured, e.g., by reconfiguring transaction data generating component 932 on terminal 806 and/or peripheral device 941.

In some implementations, terminal 806 can be configured to automatically detect when mobile device 106 is in proximity using, e.g., wireless communication. Alternatively, server 204 can transmit an indication to terminal 806 that mobile device 106 is in proximity of the business and/or terminal 806. Terminal 806 can, in turn, display or otherwise provide a notification that mobile device 106 is in the proximity of the business. In such implementations, sound can still be used to communicate the virtual transaction data between mobile device 106 and terminal 806, as discussed herein. This can provide the business owner with knowledge that an individual has a virtual punch-card accessible via their mobile device from relatively long ranges via radio, while still providing the benefits discussed herein for communicating the virtual transaction data using sound.

### Two-Way Sound Implementations

The implementations discussed above can be performed using one-way sound communication between terminal 806 and mobile device 106. However, in some implementations, two-way sound communication can be used. In such implementations, virtual transaction subsystem 810(1) of mobile device 106 can be configured with a speaker and virtual transaction subsystem 810(3) of terminal 806 can be configured with a microphone.

In such implementations, sound can be used to implement a communication protocol that can include a handshake to initialize the communications. For example, the handshake can initiate a synchronized communication protocol where predefined data fields are used to communicate virtual transaction data between mobile device 106 and terminal 806. Examples of virtual transaction data that can be communicated using one- or two-way communication are described in more detail above and below.

### Virtual Transaction Data

As mentioned above, sound can be used to transmit virtual transaction data in a variety of ways. In a relatively simple implementation, speaker 933 is permanently configured to produce a single type of sound, e.g., a frequency, chord, code, etc. that uniquely identifies the business and/or individual virtual transaction. In some implementations, receipt of this frequency, chord, or code by mobile device 106 at location 104 is sufficient to register a punch on the user's virtual punch card.

However, there is the possibility that the frequency, chord, or code identifying the business and/or individual virtual transaction could be compromised and replayed by an unauthorized device. Thus, in some implementations, the identifying frequency, chord, or code can be changed on a periodic or intermittent basis. For example, server 204 can upload data to terminal 806 indicating an identifier terminal 806 should use each day, hour, etc. to identify a particular business or individual virtual transaction. Moreover, server 204 can also upload data to mobile device 106 indicating authorized frequencies, chords, or codes that mobile device 106 should listen for when at location 104. For example, server 204 can upload individual frequencies, chords, or codes and/or media files (e.g., mp3) having such frequencies, chords, or codes. In some implementations, sound processing component 913 of mobile device 106 and/or microphone 914 is configured to disregard sound signals that are not preauthorized by server 204.

In a specific implementation, each virtual punch has a particular identification that is communicated using sound. The punch identifications can be in various forms, e.g., monotonically increasing or decreasing numbers, random numbers, letters, etc. The identifications can be communicated using Morse code, binary codes (e.g, no sound for “0” and a sound at a predetermined frequency for “1”), frequency and/or phase coding, etc.

In implementations where different identifications are used for different virtual transactions, transaction accounting component 922 can be configured to perform verification processing on individual virtual transactions. For example, transaction accounting component 922 can determine if two identical virtual punch identifications are received. In implementations where each virtual punch identification is unique, this can indicate fraudulent punches, and the virtual punch can be disallowed. However, in some implementations, virtual punch identifications are not unique, and are reused periodically. In such implementations, transaction accounting component 922 can validate virtual punches by correlating the individual virtual punch ID to the location. For example, transaction accounting component 922 can disallow duplicate virtual punch identifications from the same business within a predetermined time period. This can prevent two users from submitting the same virtual punch ID within a predetermined time period. Individual authorized punch identifications can be provided by server 204.

Encryption can also be used to further provide for secure communications using sound waves. For example, virtual punch identifications or other transaction data can be emitted by speaker 933 in the form of an encrypted bit string. In such implementations, mobile device 106 can be configured to decrypt the bit string or send the encrypted bit string to server 204 for decryption. In implementations where mobile device 106 is not configured to decrypt the bit string, mobile device 106 acts as a pass-through entity that cannot access the virtual transaction identifier, e.g., because mobile device 106 does not have a suitable decryption key. This, in turn, can prevent the virtual transaction data and/or encryption scheme from being compromised.

### Virtual Transaction Types

In the implementations discussed above, a virtual punch was used as an example of a type of virtual transaction that can be achieved using system 800. However, system 800 can be used for many different types of virtual transactions. For example, in a restaurant scenario, one terminal 806 can be located at each table. In this case, the virtual transaction could include the user receiving the bill from the restaurant via sound at their mobile device 106. Furthermore, in implementations with two-way sound communication, the user can also submit information via sound, e.g., a credit card number, for paying their bill to terminal 806. In other implementations, sound is used to transmit the bill to mobile device 106, but traditional cellular and/or wireless techniques can be used to pay the bill with mobile device 106.

Note also that, in some implementations, terminal 806 is not installed at each table. Rather, only a speaker (and possibly a microphone) is installed at each table and terminal 106 is in electronic (wired or wireless) communication with each speaker and/or microphone. In implementations where the geographic sensitivity of location component 216 is sufficiently fine-grained, virtual constraint component 218 can correlate locations to a particular table, cash register, etc. in a particular business rather than to the business location as a whole.

As another example, mobile device 106 can store a grocery list. When the user enters a grocery store, the list can be uploaded from mobile phone 106 to a grocery store terminal. The user can then be directed to the appropriate aisle for each item on the list, informed of various sales and/or coupons available for items on the list, etc. Furthermore, the user can pay for their groceries in a manner similar to the restaurant implementation discussed above.

One specific scenario can occur when the user of mobile device 106 wishes to pay for goods or services using wireless communication, e.g. wi-fi, Bluetooth, wireless 3G, etc. For each transaction, point of sale transaction component 931 can perform various processing, e.g., receiving payment, updating inventory, printing a receipt, etc. Conventionally, mobile device 106 is not involved in this processing. Using the techniques discussed herein, it is possible for terminal 806 to associate individual transactions with mobile device 106 and the user thereof. This, in turn, can allow terminal 806 to associate transaction-specific processing with mobile device 106, e.g., by accessing account information for the user.

One approach is for mobile device 106 to transmit a unique identifier to terminal 806 via sound waves. In such implementations, point of sale transaction component 931 can send the unique identifier to server 204 to look up mobile device 106 and any accounts associated with the mobile device or the user. Terminal 806 can retrieve a communication identifier that it then uses to communicate with mobile device 106 using higher-bandwidth technologies, e.g., the wireless technologies mentioned above. For example, terminal 806 can retrieve a communication identifier such as an encryption key (e.g., Rivest, Shamir and Adleman key “RSA”) and/or an identifier of a particular frequency or code for communicating with mobile device 106. Thus, the key or other communication identifier is shared using sound to bootstrap higher bandwidth communications via wireless communication.

In the manner discussed above, a relatively low bandwidth technology—sound—is used to associate a business (terminal 806) with the user (mobile device 106) to start a unique transaction. As shown in FIG. 10B, e-commerce component 911 can cause mobile device 106 to display a checkout interface 1050, which includes a start payment button 1051. When start payment button 1051 is activated, terminal 806 can populate checkout interface 1050 with various information such as the items being purchased as discussed in more detail below.

When the user of mobile device 106 activates start payment button 1050, mobile device 106 can generate a sound (e.g., a note or chords encoding the mobile device identifier). The user can place mobile phone 106 next to a microphone on terminal 806 when start payment button 1051 is being activated and the sound is being played.

Terminal 806 can process the received sound, extract the mobile device identifier, and send the identifier to server 204. Server 204 can access a user account and reply to terminal 806 with an encryption key or other communication identifier to allow terminal 806 to communicate wirelessly with mobile device 106. Terminal 806 can now send a message via wireless (3G, Bluetooth, wi-fi, etc.) to mobile device 106. For example, terminal 806 can send a wireless message to mobile device 106 that includes the items being purchased, price, tax, etc. The wireless message can also identify a confirm payment button 1052. Thus, as shown in the example of FIG. 10B, the eggs, milk, cheese, total, and prices are populated by the wireless message from terminal 106 responsive to the user pressing start payment button 1051.

If the user of mobile device 106 presses confirm payment button 1052, mobile device 106 can initiate a standard secure internet payment transaction between the business and the user's account (e.g., using asymmetric and/or symmetric encryption). The user may enter a credit card or online payment account information into mobile phone 106 to use system 800 via a secure connection from mobile device 106 to server 204. Server 204 and/or terminal 806 can email a receipt to the user's email account and/or transmit the receipt to mobile device 106 directly.

Note that various accounts can be accessed by terminal 806 to obtain the key or other identifier to enable wireless communication with mobile device 106. In some implementations, the account is particular to the business, e.g., the user could have an account with a business that is maintained at server 204. In other implementations, the account is maintained at server 204 by a more general e-commerce entity, e.g., an entity that facilitates e-commerce transactions at many different businesses. In further implementations, other accounts such as social or professional networking accounts, email accounts, virtual business cards, etc. can be used to share the key or other identifier with terminal 806.

In some implementations, mobile device 106 can include an additional non-ecommerce component (not shown) for sharing contact information or other non-ecommerce data via sound and/or wireless with terminal 806. For example, a user can share their professional contact information with terminal 806 via sound and/or bootstrapped wireless communications. Note that the user can also make a conventional payment by swiping their credit card at terminal 806, and/or use e-commerce component 911 as mentioned above.

In further implementations, e-commerce and social networking accounts can be integrated together. For example, users may be able to share virtual punches with their contacts, e.g., as a “gift” to a colleague or friend via their social networking or email account. As another example, users may distribute virtual coupons to contacts via their social networking or e-commerce accounts which can subsequently be redeemed by those users at terminal 806. In such implementations, individual virtual transaction identifiers for coupons, punches, etc. can be shared between contacts through their accounts.

### Method Examples for Sound-Based Transactions

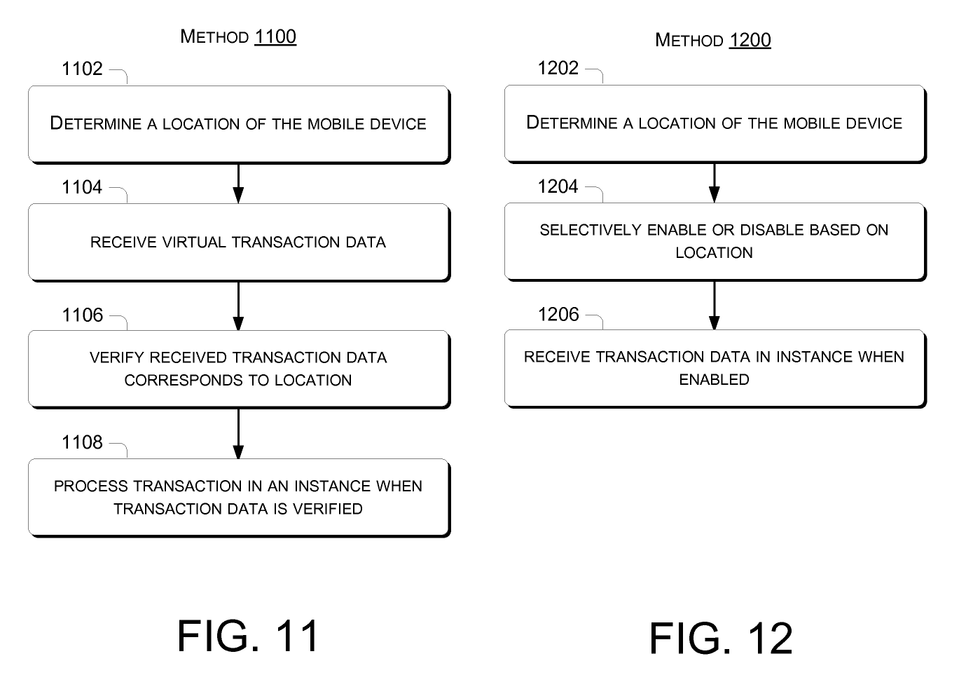

FIG. 11 illustrates a flowchart of a process, technique, or method 1100 that is consistent with at least some implementations of the present location-based user information concepts.

At block 1102, the method determines a location of a mobile device.

At block 1104, the method receives virtual transaction data from a mobile device corresponding to sound waves.

At block 1106, the method verifies that the virtual transaction data corresponds to the location of the mobile device.

At block 1108, the method processes the virtual transaction in an instance when the virtual transaction data is verified.

FIG. 12 illustrates a flowchart of a process, technique, or method 1200 that is consistent with at least some implementations of the present location-based user information concepts.

At block 1202, the method determines a location of a mobile device.

At block 1204, the method selectively enables or disables a component of the mobile device based on the location.

At block 1206, the method uses the component to receive virtual transaction data using sound waves in an instance when the component is enabled.

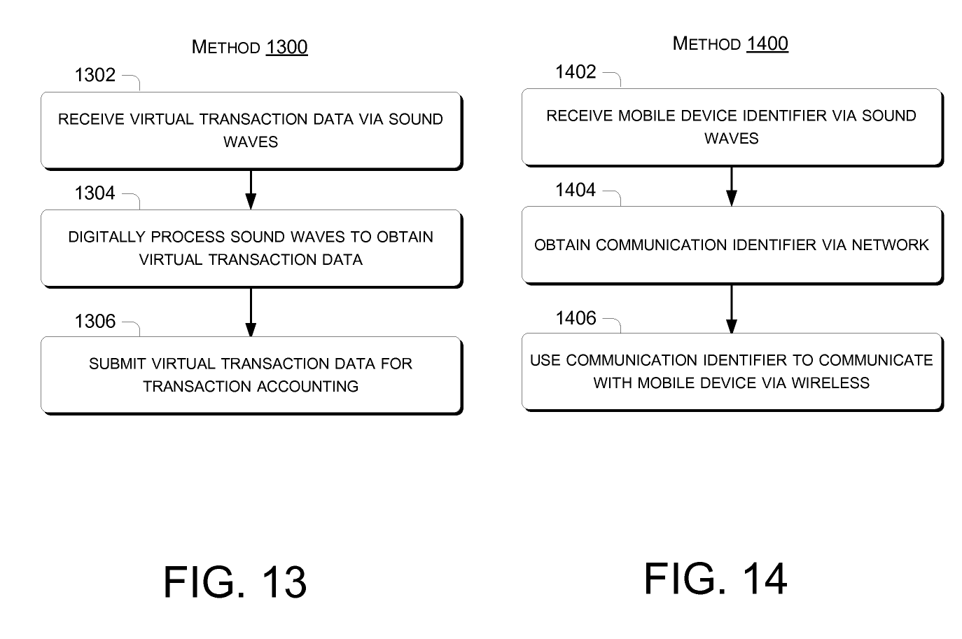

FIG. 13 illustrates a flowchart of a process, technique, or method 1300 that is consistent with at least some implementations of the present location-based user information concepts.

At block 1302, the method receives virtual transaction data via sound waves.

At block 1304, the method digitally processes the sound waves to obtain the virtual transaction data.

At block 1306, the method submits the virtual transaction data for transaction accounting.

FIG. 14 illustrates a flowchart of a process, technique, or method 1400 that is consistent with at least some implementations of the present location-based user information concepts.

At block 1402, the method receives a mobile device identifier via sound waves.

At block 1404, the method uses the mobile device identifier to obtain a communication identifier via a network.

At block 1406, the method uses the communication identifier to wirelessly communicate with the mobile device.

### ADDITIONAL IMPLEMENTATIONS

In the implementations discussed above, particular devices performed particular functions. However, these implementations are intended to be exemplary, and, in many cases, the various functionality described above can be alternatively performed by different devices and/or components thereof. As mentioned above, terminal 806 can perform any or all of the functionality discussed above with respect to server 204. For example, terminal 806 can perform accounting and/or geographic verification processing, etc.

As another example, in the implementations discussed above, server 204 sends certain instructions to mobile device 106, e.g., to turn on or off certain components, listen for sound, etc. In some implementations these instructions can be sent via terminal 806 to mobile device 106 using wireless and/or sound. As another example, mobile device 106 can perform these techniques autonomously.

Furthermore, note that the order in which the above listed methods are described is not intended to be construed as a limitation, and any number of the described blocks or acts can be combined in any order to implement the method, or an alternate method. The disclosed methods can be implemented in any suitable hardware, software, firmware, or combination thereof such that a computing device can implement the method and/or cause the method to be implemented. In one case, the methods are stored on computer-readable storage media as instructions such that execution by a computing device causes the method to be performed.

1. A method comprising:
determining a location of a mobile device; and
in an instance where the location of the mobile device is proximate to a business location associated with a business, presenting a virtual feature associated with the business on the mobile device.

2. The method according to claim 1, wherein the virtual feature comprises a punch card.

3. The method according to claim 2, further comprising uploading a credit to an account associated with the punch card.

4. The method according to claim 3, wherein the credit reflects a number of items purchased by the user at the business location.

5. The method according to claim 2, further comprising:
determining a second location of the mobile device subsequent to determining the first location; and
in an instance where the second location of the mobile device is proximate to a second business location that is also associated with the business, presenting the punch card on the mobile device.

6. The method according to claim 2, further comprising:
responsive to the location of the mobile device being proximate to the business location, providing a prompt on the mobile device for the user to have the virtual punch card credited.

7. A mobile device comprising:
a microphone configured to receive sound waves comprising transaction data; and
a transaction data submitting component configured to submit the transaction data for transaction accounting.

8. The mobile device according to claim 7, further comprising a sound processing component configured to convert the sound waves to a digital representation of the sound waves.

9. The mobile device according to claim 8, wherein:
the sound processing component is further configured to derive the transaction data from the digital representation of the sound waves; and
the transaction data submitting component is configured to submit the derived transaction data.

10. The mobile device according to claim 8, wherein:
the sound processing component is not configured to derive the transaction data from the digital representation of the sound waves, and
the transaction data submitting component is configured to submit the digital representation of the sound waves for transaction accounting.

11. The mobile device according to claim 8, further comprising a virtual constraint component that is configured to prevent the mobile device from submitting the transaction data based on a location of the mobile device.

12. The mobile device according to claim 11, wherein the virtual constraint component is configured to prevent the mobile device from submitting the transaction data by rendering the microphone, the sound processing component, or the transaction data submitting component at least partly inoperable unless the mobile device is proximate to a location associated with a business.

13. A system comprising:
a transaction data generating component configured to generate transaction data; and
a speaker configured to play a sound comprising the transaction data.

14. The system according to claim 13, wherein the transaction data corresponds to a virtual punch for a virtual punch card.

15. The system according to claim 14, wherein the sound comprises a predetermined frequency or code that identifies the virtual card punch.

16. The system according to claim 14, wherein the predetermined frequency or code identifies a business where the speaker is located.

17. The system according to claim 13, wherein the sound played by the speaker further comprises a timestamp corresponding to the transaction data.

18. The system according to claim 13, wherein the speaker is configured to play the sound at an inaudible frequency.

19. The system according to claim 18, wherein the speaker is further configured to play a second sound at an audible frequency, the second sound indicating that the transaction data has been played using the inaudible frequency.

20. The system according to claim 13, further comprising a point of sale transaction component configured to cause the speaker to play the sound responsive to a purchase by a user.

21. The system according to claim 13, implemented on a peripheral device.

22. The system according to claim 21, wherein the peripheral device is embodied as a universal serial bus dongle or drive.

23. A method comprising:
receiving a mobile device identifier from a mobile device via sound waves;
obtaining a communication identifier using the mobile device identifier; and
using the communication identifier to communicate wirelessly with the mobile device.

24. The method according to claim 23, wherein the obtaining comprises sending the mobile device identifier to a server, and receiving the communication identifier from the server.

25. The method according to claim 23, wherein the communication identifier comprises an encryption key that is particular to the mobile device.

26. The method according to claim 25, wherein the encryption key is used to encrypt or decrypt wireless communications with the mobile device.

27. The method according to claim 23, further comprising using the wireless communication to send virtual transaction data to the mobile device.

28. The method according to claim 27, wherein the virtual transaction data comprises a bill for goods or services.
